(19) United States
(12) Patent Application Publication
(10) Pub. No.: US 2025/0203162 A1
(43) Pub. Date: Jun. 19, 2025

(54) WEATHER BASED CONTENT RECOMMENDATIONS

(71) Applicant: DISH Network L.L.C., Englewood, CO (US)

(72) Inventors: Jared Backofen, Colorado Springs, CO (US); Rajiv Pal, Casper, WY (US)

(21) Appl. No.: 18/541,806

(22) Filed: Dec. 15, 2023

(51) Int. Cl. H04N 21/466

(52) U.S. Cl. CPC H04N 21/4668

(57) ABSTRACT

The present disclosure is directed to methods and systems for dynamic content recommendation. A method may include accessing a user's viewership history stored in non-transitory memory; obtaining real-time weather information relevant to a weather condition at a geographical location of the user; and dynamically generating, for presentation, a content recommendation using a recommendation algorithm and based on the viewership history and the real-time weather information, in which the recommendation algorithm includes a neural network based collaborative filtering algorithm that is trained to adapt recommendations based on patterns identified in viewership information and corresponding weather information.

### BACKGROUND

A wide variety and numerous content items are available, accompanied by services that recommend these items to users based on various criteria. Content recommendation services may enhance user experience by helping users discover content that they may find interesting or useful.

### SUMMARY

Aspects of the present disclosure are directed to methods and systems for content recommendation. The methods and systems can dynamically generate content recommendation based on user preference and real-time weather information. The content recommendation may include at least one content item of linear content, on-demand content, or streaming content.

An aspect of the present disclosure relates to a computer-implemented method for dynamic content recommendation. The method may include: accessing a user's viewership history stored in non-transitory memory; obtaining real-time weather information relevant to a weather condition at a geographical location of the user; and dynamically generating, for presentation, a content recommendation using a recommendation algorithm and based on the viewership history and the real-time weather information. In some embodiments, the recommendation algorithm may include a neural network based collaborative filtering algorithm that is trained to adapt recommendations based on patterns identified in viewership information and corresponding weather information.

In some embodiments, the method may include obtaining the real-time weather information via an automated data retrieval system interfacing with external weather data sources.

In some embodiments, the method may include receiving user feedback through a user interface; and updating the content recommendation based on the user feedback.

In some embodiments, the content recommendation may be specific to digital media.

In some embodiments, the method may include identifying content available at the geographical location of the user; and evaluating the identified content against the user's viewership history and real-time weather information, wherein the generated content recommendation comprises content to watch in real-time or within a time window based on the evaluation.

In some embodiments, the method may include notifying the user of an upcoming content that aligns with the user's viewership history and the weather information.

In some embodiments, the generated content recommendation may include a plurality of content items, and the method may include ranking the plurality of content items based on their respective relevance to the weather information and/or the user's historical viewing patterns.

In some embodiments, the method may include identifying weather-themed content that is themed around the weather condition; and including the weather-themed content in the content recommendation.

In some embodiments, the method may include generating a weather-related alert to the user based on the real-time weather information. For example, the weather-related alert may include a notification about at least one of a severe weather condition, a weather forecast change, or a safety warning.

In some embodiments, the method may include integrating the real-time weather information into the content recommendation.

In some embodiments, the method may include selecting a content item that is thematically related to the weather condition.

In some embodiments, the method may include recommending a set of weather-appropriate activities to the user based on the real-time weather information, the user's viewership history, and/or the user's geographical location.

In some embodiments, the method may include providing an educational content or advice related to weather preparedness based on the real-time weather information, the user's viewership history, and/or the user's geographical location.

In some embodiments, the method may include retrieving the geographical location of the user based on a location of a receiving device through which the generated content recommendation is received for presentation to the user.

In some embodiments, the method may include providing a real-time alert to the user regarding a weather change relevant to a planned activity. In some embodiments, the method may include generating a suggestion including alternative activities or content based on these weather changes.

In some embodiments, the method may include monitoring the real-time weather information with respect to a change in the weather condition; and adjusting the content recommendation based on a change in the weather condition that is detected during the monitoring.

In some embodiments, the method may include receiving authentication information from the user; and retrieving the user viewership history based on the authentication information.

Another aspect of the present disclosure relates to a system for content recommendation. The system may include one or more processors; and one or more memories storing instructions that, when executed by the one or more processors, cause the system to perform operations including accessing a user's viewership history stored in a non-transitory memory; obtaining real-time weather information relevant to a weather condition at a geographical location of the user; and dynamically generating, for presentation, a content recommendation using a recommendation algorithm and based on the viewership history and the real-time weather information. In some embodiments, the recommendation algorithm may include a machine learning model that is trained to adapt recommendations based on patterns identified in viewership information and corresponding weather information.

A further aspect of the present disclosure relates to a system for content recommendation. The system may include a data storage device for storing users' viewership histories; one or more processors equipped with a machine learning algorithm, in which the one or more processors may be configured to (1) fetch weather information in real-time, and (2) dynamically generate a content recommendation using the machine learning algorithm and based on viewership histories and the weather information; and a transmission device configured to transmit the generated content recommendations to user terminal devices.

In some embodiments, the one or more processors of the system may be further configured to update a content recommendation in response to at least one of a real-time change in the weather information or user interaction data.

In some embodiments, the one or more processors of the system may be further configured to access a content schedule of content from one or more content providers; integrate the content schedule with a viewership history of a user and real-time weather information relevant to the user; and dynamically generate a content recommendation for linear content based on an integrated analysis of the content schedule, the viewership history of the user, and the real-time weather information relevant to the user. The content recommendation may include at least one content item of linear content, on-demand content, or streaming content.

In some embodiments, the one or more processors of the system may be further configured to monitor real-time changes in the content schedule, the viewership history of the user, and the real-time weather information relevant to the user; and adjust the content recommendation based on a change that is detected during the monitoring.

In some embodiments, the one or more processors of the system may be further configured to categorize content items based on weather themes; and tag the content items based on respective content categories.

In some embodiments, the transmission device of the system may be configured to communicate with a receiving device through which a generated content recommendation is transmitted to a user terminal device.

In some embodiments, the one or more processors of the system may be further configured to determine a geographical location of a user based on information of the receiving device; and fetch, based on the geographical location of the user, weather information in real-time relevant to the user for generating a content recommendation for the user.

A further aspect of the present disclosure relates to one or more non-transitory computer-readable media storing instructions that, when executed by one or more processors, implement operations for content recommendation. The operations may include accessing a user's viewership history stored in a non-transitory memory; obtaining real-time weather information relevant to a weather condition at a geographical location of the user; and dynamically generating, for presentation, a content recommendation using a recommendation algorithm and based on the viewership history and the real-time weather information. In some embodiments, the recommendation algorithm may include a machine learning model that is trained to adapt recommendations based on patterns identified in viewership information and corresponding weather information.

### BRIEF DESCRIPTION OF THE DRAWINGS

FIG. 1 illustrates an example of a system for generating content recommendations in accordance with embodiments of the present disclosure.

FIG. 2 illustrates an example input processing system for implementing systems and methods for generating content recommendations in accordance with embodiments of the present disclosure.

FIG. 3 is a flow diagram illustrating a process used in some implementations for generating a content recommendation in accordance with embodiments of the present disclosure.

FIG. 4 illustrates an example environment of operation of the disclosed technology.

FIG. 5 illustrates one example of a suitable operating environment in which one or more of the present embodiments may be implemented.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to methods and systems for dynamic content recommendation based on user preference and real-time context information. For illustration purposes and not intended to be limiting, systems and methods for dynamic content recommendation are described with reference to a user's prior viewership history that is indicative of user preference and real-time weather information as exemplary real-time context information.

Prior viewership information may reflect a user's preference and accordingly allow a content recommendation system to personalize suggestions based on a user's past interests and viewing habits. This can lead to more relevant and engaging content for the user. Meanwhile, weather may have a significant impact on how people behave. Weather may also affect the user's mood and viewing choice. Accordingly, incorporating weather information can add a contextual layer to content recommendations. For instance, on rainy days, a system may recommend cozy, indoor-themed movies or shows, enhancing the user's viewing experience by aligning with the current weather condition. By combining a user's viewership history with weather data (to obtain a modified user preference), recommendations can become more dynamic and responsive to both the user's preferences and their immediate context, thereby increasing user engagement and satisfaction with the system. This may also enhance the system's performance by streamlining content recommendation and retrieval processes and avoiding less focused or random recommendations so that the system may operate efficiently and remain responsive and accurate despite the need to deal with a vast amount of data.

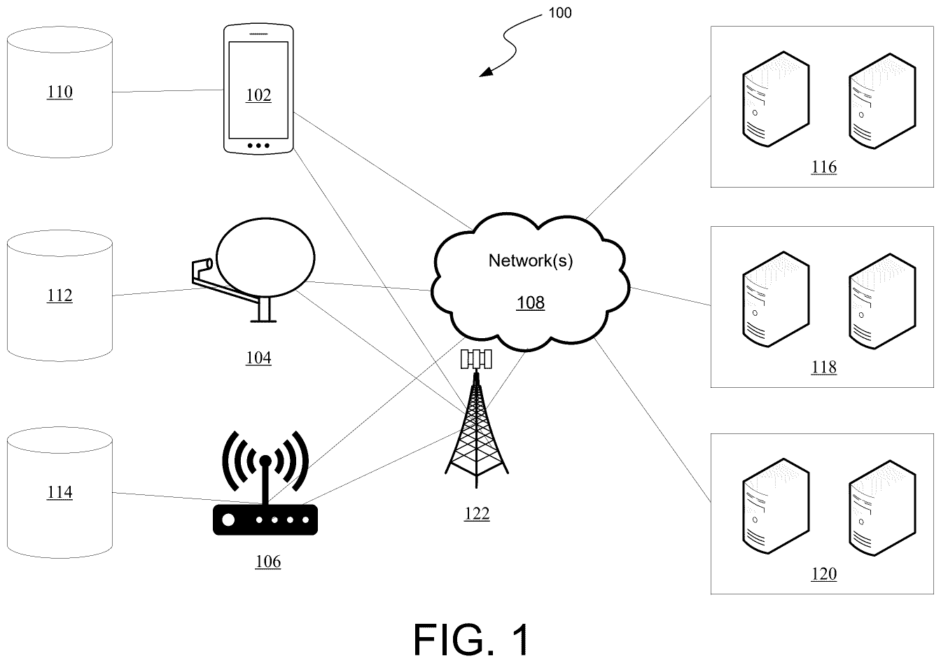

FIG. 1 illustrates an example of a system for generating content recommendations. Example system 100 presented is a combination of interdependent components that interact to form an integrated whole for providing content recommendations to users. Components of the systems may be hardware components or software implemented on, and/or executed by, hardware components of the systems. For example, system 100 includes client devices 102, 104, and 106, local databases 110, 112, and 114, network(s) 108, and server devices 116, 118, and/or 120.

Client devices (also referred to as user terminal devices) 102, 104, and 106 may be configured to exchange information with one or more other components of system 100. In some embodiments, a client device 102 may be a mobile phone, a client device 104 may be a smart OTA antenna, and a client device 106 may be a broadcast module box (e.g., set-top box). In some embodiments, client device 106 may be a gateway device (e.g., router) that is in communication with sources, such as internet service providers (ISPs), cable networks, or satellite networks. Additional examples of client devices include tablets, personal computers, televisions, etc. In some embodiments, a client device, such as client devices 102, 104, and 106, may have access to one or more networks from a gateway. In some embodiments, client devices 102, 104, and 106, may be equipped to receive data from a gateway. The signals that client devices 102, 104, and 106 may receive may be transmitted from satellite broadcast tower 122. Broadcast tower 122 may also be configured to communicate with network(s) 108, in addition to being able to communicate directly with client devices 102, 104, and 106. In some examples, a client device may be a receiving device (e.g., a set-top box) that is connected to a display device, such as a television (or a television that may have set-top box circuitry built into the television mainframe).

Client devices 102, 104, and 106 may be configured to run software that identifies metadata of user profiles, determines profiles that have similar attributes, sends recommendation for user to join a group, generates a multiple user profile for the group, and provides media content recommendations. Client devices 102, 104, and 106 may access content data through the networks. The content data may be stored locally on the client device or run remotely via network(s) 108. For example, a client device may receive a signal from broadcast tower 122 containing content data. The signal may indicate user requested media content. The client device may receive this user requested content data and subsequently store this data locally in databases 110, 112, and/or 114. In alternative scenarios, the user requested content data may be transmitted from a client device (e.g., client device 102, 104, and/or 106) via network(s) 108 to be stored remotely on server(s) 116, 118, and/or 120. A user may subsequently access the media content data from a local database (110, 112, and/or 114) and/or external database (116, 118, and/or 120), depending on where the media content data may be stored. The system may be configured to receive and process user requested content data in the background.

In some example aspects, client devices 102, 104, and/or 106 may be equipped to receive signals from an input device. Signals may be received on client devices 102, 104, and/or 106 via Bluetooth, Wi-Fi, infrared, light signals, binary, among other mediums and protocols for transmitting/receiving signals. For example, a user may use a mobile device 102 to check for the content data from a channel from an OTA antenna (e.g., antenna 104). A graphical user interface may display on the mobile device 102 the requested content data, a content recommendation, a notification or alert, or the like, or a combination thereof. Specifically, at a particular geolocation, the antenna 104 may receive signals from broadcast tower 122. The antenna 104 may then transmit those signals for analysis via network(s) 108. The results of the analysis may then be displayed on mobile device 102 via network(s) 108. In other examples, the results of the analysis may be displayed on a television device connected to a broadcast module box, such as broadcast module box 106.

In other examples, databases stored on remote servers 116, 118, and 120 may be utilized to assist the system in recommending and/or providing content to a user from a gateway with multiple networks. Such databases may contain certain content data (e.g., metadata) such as video titles, actors in movies, video genres, etc. Such data may be transmitted via network(s) 108 to client devices 102, 104, and/or 106 to assist in identifying user requested media content. Because broadcast tower 122 and network(s) 108 are configured to communicate with one another, the systems and methods described herein may be able to identify requested media content in different sources, such as streaming services, local and cloud storage, cable, satellite, or OTA.

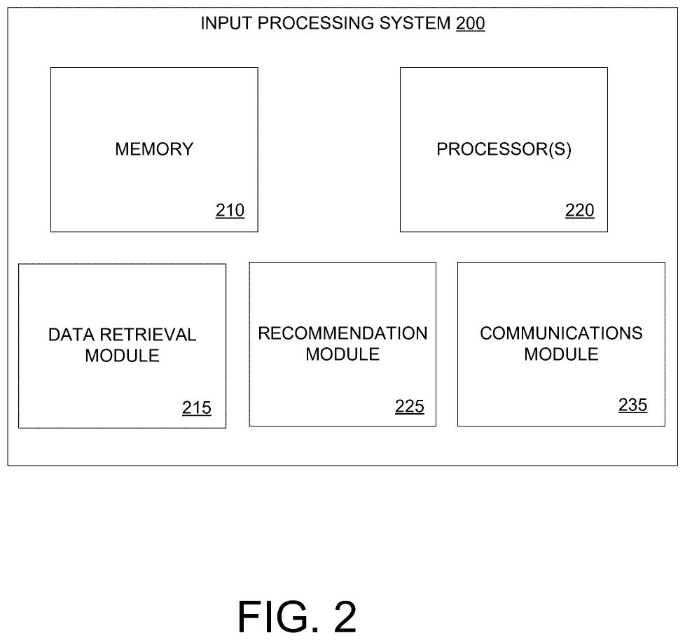

FIG. 2 illustrates an example input processing system for implementing systems and methods for generating content recommendations. The input processing system 200 (e.g., one or more data processors) is capable of executing algorithms, software routines, and/or instructions based on processing data provided by a variety of sources related to identifying metadata of user profiles, determining user profiles that have similar attributes, sending recommendation for users to join a group, generating a multiple user profile for the group, and providing media content recommendations. The input processing system 200 can be a general-purpose computer or a dedicated, special-purpose computer. According to the embodiments shown in FIG. 2, the input processing system 200 can include memory 210, one or more processors 220, data retrieval module 215, recommendation module 225, and communications module 235. Other embodiments of the present technology may include some, all, or none of these modules and components, along with other modules, applications, data, and/or components. Still yet, some embodiments may incorporate two or more of these modules and components into a single module and/or associate a portion of the functionality of one or more of these modules with a different module.

Memory 210 can store instructions for running one or more applications or modules on processor(s) 220. For example, memory 210 may be used in one or more embodiments to house all or some of the instructions needed to implement the functionality of data retrieval module 215, recommendation module 225, and/or communications module 235; processor(s) 220 may be used to execute the instructions to implement the implement the functionality of data retrieval module 215, recommendation module 225, and communications module 235.

In some embodiments, memory 210 can include any device, mechanism, or populated data structure used for storing information. In accordance with some embodiments of the present disclosures, memory 210 can encompass, but is not limited to, any type of volatile memory, nonvolatile memory, and dynamic memory. For example, memory 210 can be random access memory, memory storage devices, optical memory devices, magnetic media, floppy disks, magnetic tapes, hard drives, SIMMs, SDRAM, RDRAM, DDR, RAM, SODIMMs, EPROMs, EEPROMs, compact discs, DVDs, and/or the like. In accordance with some embodiments, memory 210 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information that can be used as memory 210. In some example aspects, memory 210 may store at least one database containing the customizable features of the networks, a prioritized order of the networks, or user requested content information, such as audio or video data.

Processor(s) 220 may include one or more programmable processors executing one or more computer programs to perform functions by operating on input data and generating output. Processor(s) 220 may also be implemented as, special purpose logic circuitry, e.g., an FPGA (field programmable gate array) or an ASIC (application specific integrated circuit). Processor(s) 220 may include both general and special purpose microprocessors, and any one or more processors of any kind of digital computer.

Data retrieval module 215 may be configured to fetch and/or process data via, e.g., communications module 235. For example, data retrieval module 215 may be configured to obtain a user's viewership history (e.g., prior viewership information) from memory (e.g., memory 210, an external storage device in communication with data retrieval module 215, a set-top box, an application). As another example, data retrieval module 215 may retrieve time-dependent weather information from one or more data sources. These sources may include national or regional meteorological services, satellite data, weather application programming interfaces (APIs) provided by third-party services, and other relevant databases that offer real-time or forecasted weather data. As a further example, data retrieval module 215 may be configured to receive user input (e.g., user feedback in response to a content recommendation, a user selection of a content item from the content recommendation).

In some embodiments, data retrieval module 215 may be configured to automatically retrieve data (e.g., weather data) at regular intervals or in real-time. Merely by way of example, an automated weather data retrieval process may be managed by scheduled tasks or triggers that prompt data retrieval module 215 to connect to the data sources and pull the latest information.

In some embodiments, data retrieval module 215 may be configured to pre-process retrieved data. Merely by way of example, data retrieval module 215 may clean, normalize, fuse, and/or harmonize retrieved data to verify data validity and/or to achieve data consistency, label data with timestamps that indicate the corresponding acquisition time of the data (e.g., labeling weather information with its retrieval time to facilitate assessment of whether the weather information is current), standardize units of measurement, align time of data (e.g., weather information for different days or different hours of a same day), and reconcile discrepancies between different data sources, or the like, or a combination thereof. For example, if the data are sourced from multiple providers, data retrieval module 215 may convert different data formats into a standardized format used by recommendation module 225. As another example, data retrieval module 215 may be configured to detect and/or handle errors or data retrieval failures, such as retrying connections or switching to alternative data sources, thereby ensuring reliability of data retrieval and performance of input processing system 200.

In some embodiments, data retrieval module 215 may be configured to tag content items to facilitate searching of such content items. For example, data retrieval module 215 may categorize content items based on weather themes; and tag the content items based on respective content categories. The content items tagged with weather themes may be stored in a content database. In some embodiments, such content items may include metadata indicating other information of the content items including, e.g., genre, creator, actor, etc. Such metadata and weather theme tags may be used individually or concurrently to facilitate searching of the content items. In some embodiments, the weather theme tags may be added by a device other than data retrieval module 215. For example, at least one weather theme tag may be added to a content item manually by a creator of the content item, or by a processing device belonging to or operably connected with the content database as part of pre-processing of the content item for storage in a content database.

Data retrieval module 215 may be tightly integrated with recommendation module 225. This integration may allow recommendation module 225 to utilize the latest data (e.g., current weather data, a current content schedule, a user input) in combination with user viewership history for dynamically generating content recommendations.

Recommendation module 225 may be configured to analyze information including, e.g., users' viewership histories, weather information, to determine content recommendations based on a recommendation algorithm. Recommendation module 225 may be configured to retrieve the information as input from, e.g., data retrieval module 215. In some embodiments, the recommendation algorithm may include at least one machine-learning algorithms (and models). The at least one machine-learning algorithms (and models) may be stored locally at databases and/or externally at databases (e.g., cloud databases and/or cloud servers).

As described herein, a machine-learning (ML) model may refer to a predictive or statistical utility or program that may be used to determine a probability distribution over one or more character sequences, classes, objects, result sets or events, and/or to predict a response value from one or more predictors. A model may be based on, or incorporate, one or more rule sets, machine learning, a neural network, or the like. The ML models may process user profiles and other data stores of user data (e.g., social media accounts, user profile settings, user preferences, viewing history (also referred to as viewership history), etc.) and real-time weather information (or other context information) to generate a content recommendation. Determining a content recommendation may include identifying various attributes of a user's viewership history and weather information and selecting content items with related attributes (e.g., one or more weather-themed content items). Based on an aggregation of data from a user's viewing history, user profile, location, device settings, a weather condition, and other user data stores, at least one ML model may be trained and subsequently deployed to automatically select content items for recommending to the user. The trained ML model may be deployed to one or more devices. The machine learning model may undergo continuous training and/or updating. It adjusts its pattern recognition based on new data, enhancing its ability to make accurate predictions over time. This ML model may be trained based on techniques like supervised learning, where the model is trained on a labeled dataset, or unsupervised learning, where it identifies patterns without pre-labeled data.

In examples, the ML models may be located on a client device, a server device, a network appliance (e.g., a firewall, a router, etc.), or a combination thereof. As a specific example, an instance of a trained ML model may be deployed to a server device and to a client device. The ML model deployed to a server device may be configured to be used by the client device when, for example, the client device is connected to the internet. Conversely, the ML model deployed to a client device may be configured to be used by the client device when, for example, the client device is not connected to the internet. In some instances, a client device may be disconnected from the internet but still configured to receive satellite signals with information (e.g., multimedia information, channel guides). In such examples, the ML model may be locally cached by the client device.

Communications module (also referred to as transmission device) 235 is associated with sending/receiving information (e.g., content recommendations from recommendation module 225, weather information from an external source, geographical location information of a user or client device, a content schedule from a content provider) with a remote server or with one or more client devices, streaming devices, routers, OTA boxes, set-top boxes, etc. These communications can employ any suitable type of technology, such as Bluetooth, WiFi, WiMax, cellular, single hop communication, multi-hop communication, Dedicated Short Range Communications (DSRC), or a proprietary communication protocol. In some embodiments, communications module 235 sends recommendation information identified by the recommendation module 225. Furthermore, communications module 235 may be configured to communicate content data to a client device and/or OTA box, router, smart OTA antenna, and/or smart TV, etc.

Various components of input processing system 200 may be configured to acquire, process, and update data in real-time or near real-time such that input process system 200 may make accurate decisions (e.g., content recommendations) based on most current information (e.g., current weather information, current content scheduling information, user feedback, etc.). Input processing system 200 may be designed to be scalable, capable of handling large volumes of data and spikes in data retrieval and/or processing requests, so that its performance remains consistent even under high demand. Input processing system 200 may include security measures to protect the integrity of the data transfer and storage, considering the system's connection to external sources.

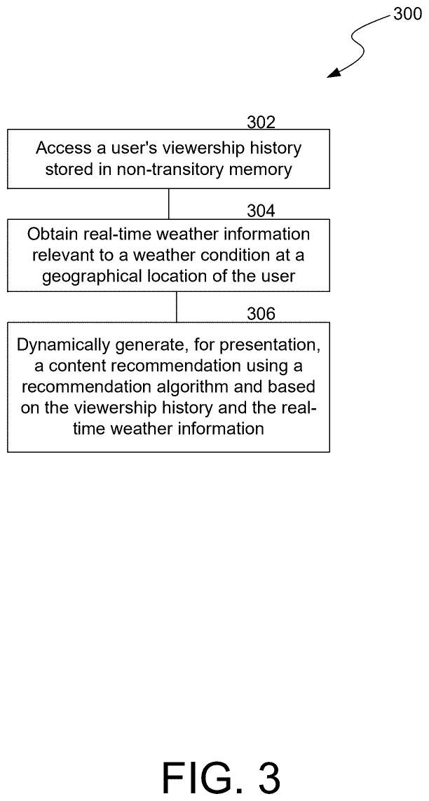

FIG. 3 is a flow diagram illustrating a process 300 used in some implementations for generating a content recommendation. In some implementations, process 300 is triggered by a user activating a subscription for accessing media content, powering on a device, a device connecting to a gateway (e.g., router), powering on the gateway, the gateway connecting to a source (e.g., ISP, cable network, satellite network, etc.), a user requesting recommendations, or the user downloading an application on a device for receiving content and/or content recommendations. In various implementations, process 300 is performed locally on the user terminal device or performed by remote or cloud-based device(s) (e.g., input processing system 200) that can provide/support providing content and/or recommendations.

At block 302, process 300 can include accessing a user's viewership history stored in non-transitory memory (e.g., memory 210, or an external storage device where the user's viewership history is stored). In some embodiments, process 300 may include retrieving the user's viewership history via data retrieval module 215.

A user's viewership history may include a record of what the user has watched over a period of time. Merely by way of example, in the context of digital media and online platforms, a user's viewership history may involve tracking and storing the information about TV shows, movies, videos, or other content that the user has viewed. This data can include, e.g., titles watched (e.g., the specific names of shows, movies, or videos), viewing duration (e.g., how long the user watched a particular piece of content), viewing frequency (e.g., how often the user watches content or visits the platform), interest (e.g., types of genres or specific content creators the user tends to watch), time and/or date of viewing (e.g., time of day and/or day of the week when the user watched the content), interaction data (e.g., actions like pausing, rewinding, fast-forwarding, providing a rating, adding to a watchlist), content types (e.g., different types of content such as TV shows, movies, live broadcasts, sports events, documentaries, user-generated content), viewing context (e.g., whether the user watched the content on a mobile device or a home TV), platform or channel information (e.g., different streaming services, cable TV, etc., through which the user accesses different pieces of content), context information (e.g., the weather condition when the user watched a piece of content), or the like, or a combination thereof. A user's viewership history may be identified based on an account of the user, e.g., a subscription account with a TV service. In cases where multiple users share a single account (like a family using a streaming service), the history may be segmented into different user profiles to record the viewership history for each user. A user's viewership history may span different lengths of time, ranging from recent views (like the past week or month) to long-term patterns (several months or even years). Process 300 may include accessing the user's viewership history of a certain period, e.g., within the last week, last month, last quarter, last year, last few years, etc.

Process 300 may trigger privacy and/or data security considerations for its involvement of personal data including, e.g., viewership information, location information, personal activities or schedule information. In some embodiments, process 300 may include measures for improving privacy and/or data security. For example, process 300 may include assessing authentication information before accessing the user's prior viewership information. For example, process 300 may include receiving authentication information from the user, and retrieve the user viewership history based on the authentication information. In some embodiments, authentication information may include subscription information relating to a set-top box or an application via which a content recommendation is sent to the user. Accessing a viewership history through a user's subscription information may allow for a more secure and controlled environment. Subscription accounts are typically protected by passwords and may have additional security measures like two-factor authentication, which helps in safeguarding user data. Additionally or alternatively, by tying an access to a user's viewership history to a specific set-top box or an application account, the data access is controlled and limited, and the viewership history is specific and focused (to content only accessed by the user, not unauthorized users) considering that only those with authorized access to the set-top box or the application (usually the subscriber and their household) can access the content (on the basis of which viewership history is built), reducing the risk of unauthorized data breaches. Moreover, data (e.g., authentication information, a user's viewership history) transmitted from the set-top box or an application during process 300 (e.g., to input processing system 200) may be encrypted. Accordingly, even if the data transmission is intercepted, the contents may remain secure and unreadable to unauthorized parties. In addition, the user's provision of authentication information for accessing a subscription account may constitute a clear user consent for data collection and processing in compliance with data protection laws like GDPR or CCPA. Users typically agree to terms of service when subscribing, which can include clauses about viewership data usage for content recommendations.

A user's viewership history may be indicative of the user's preference. Additionally or alternatively, process 300 may include assessing the user's preference from other information including, e.g., the user's search or purchase history on a platform. In some embodiments, process 300 may include integrating the user's viewership histories or other information indicative of the user preference from multiple sources (e.g., multiple platforms) to create a comprehensive dataset regarding the user preference.

At block 304, process 300 can include obtaining real-time weather information relevant to a weather condition at a geographical location of the user. Weather information includes data points like temperature, precipitation, humidity, and specific weather events (e.g., sunny, rainy, cloudy, windy, tropical storm, hurricane, snow, temperature, season, humidity, or the like, or a combination thereof), daily high temperature, the chance of rain, the air quality index, or the like, or a combination thereof. Merely by way of example, weather events may be categorized (e.g. sunny=0, rain=1). As another example, temperature may be recorded on a continuous scale, or categorized based on temperature ranges (e.g., 0° C.-5° C.=0; 5° C.-10° C.=1, 10° C.-15° C.=2). As a further example, season may be categorized (e.g., spring=0, summer=1).

The real-time weather information may be with respect to a weather condition for a current time point or time period (when the content recommendation is to be generated and/or presented to the user) or a weather condition for a future time point or time period (after the time point when the content recommendation is to be generated and/or presented to the user). In some embodiments, process 300 may include obtaining the real-time weather information via an automated data retrieval system (e.g., data retrieval module 215 as illustrated in FIG. 2) interfacing with external weather data sources. Merely by way of example, process 300 may include aggregating weather data from various sources to create a comprehensive and current dataset regarding real-time weather information. For example, process 300, via data retrieval module 215, may include combining satellite data for large-scale weather patterns, local weather station data for specific area conditions, and forecasts from commercial services. This aggregation may allow checks to validate the accuracy and reliability of the weather information by cross-referencing data points from multiple sources.

Process 300 may include tailoring the weather data to the user's specific geographical location. For example, process 300 may include identifying the most relevant data source(s) for weather information of a geographic area where the user is so that process 300 may include providing a content recommendation based on a local weather condition. In some embodiments, process 300 may include retrieving the geographical location of the user based on information of a receiving device (e.g., a set-top box, a user terminal device) through which the generated content recommendation is received for presentation to the user. For example, process 300 may include identifying the location of the set-top box based on an identifier (used to differentiate one set-top box from another in a network) or the IP address of the set-top box, and/or a service address associated with the user.

At block 306, process 300 can include dynamically generating, for presentation, a content recommendation using a recommendation algorithm and based on the viewership history and the real-time weather information. In some embodiments, recommendation module 225 of input processing system 200 may generate a content recommendation as described herein.

In some embodiments, the recommendation algorithm includes a neural network based collaborative filtering algorithm. The recommendation algorithm may be trained to adapt recommendations based on patterns identified in viewership information and corresponding weather information. As used herein, correspondence between viewership information and weather information of a user indicates correspondence or coincidence in terms of location and time between the two. For example, viewership information A and weather information B of a user are considered corresponding to each other when viewership information A records information regarding a specific content item the user watched at time I and at location II and weather information B records the weather condition at (or around) time I and at (or near) location II. More descriptions regarding viewership information and weather information may be found elsewhere in the present disclosure. See, e.g., relevant descriptions with respect to data retrieval module 215 and blocks 302 and 304, which are not repeated here.

In some embodiments, the recommendation algorithm may be configured to integrate input information including, e.g., the user's viewership history and real-time weather information, and identify a tendency for the user to watch certain types of content (e.g., movies or shows) during specific weather conditions (e.g., preferring comforting movies on rainy days, preferring outdoor sports on sunny days, etc.). The recommendation algorithm may consider additional input information including, e.g., geographical location of the user, viewership information of other users sharing at least one common feature with the user (e.g., users at the same geographical location, age, etc.). The geographical location of the user may relate to one or more of the following: the real-time weather information, available content to be recommended, suitable or popular activities that in turn relate to candidate content to be recommended, etc.

Merely by way of example, the recommendation algorithm may analyze the input information by performing matrix factorization on the fly (when process 300 is triggered as described elsewhere in the present disclosure) and identify one or more content items for recommendation based on the trained neural network based collaborative filtering algorithm. The matrix factorization may take a large, complex matrix corresponding to the input data (including, e.g., the user's viewership history and real-time weather information) and break it down (by factorizing it) into multiple, simpler matrices whose product approximates the original matrix, to uncover latent features underlying the interactions between different dimensions represented by the matrix that corresponds to the input data. The matrix factorization may be implemented by, e.g., singular value decomposition (SVD), alternating least squares (ALS), non-negative matrix factorization (NMF).

Content items to be recommended may be identified based on the matrix factorization and a similarity metric in the form of, e.g., K-nearest neighbors (k-NN), cosine similarity, etc. The similarity metric can measure how closely a user's modified preference (by combining the user's viewership history and the weather data) align with the attributes of a candidate content item. This may be determined by comparing the user-weather combined vector (derived from the matrix factorization of the user's modified preference) with factorized attributes of a candidate content item. The similarity metric can compare two candidate content items to determine how similar they are in the context of the user's modified preference to identify similar content items for recommendation to the user.

The recommendation algorithm may be configured to personalize recommendations for different users based on the unique patterns identified in their viewership and weather data. For example, two different users may receive different recommendations under similar weather conditions, reflecting their individual preferences. By balancing diverse training data, the recommendation algorithm may be trained to be contextually sensitive, so that it not only considers direct preferences and weather conditions but also contextual factors including, e.g., time of day, day of the week, seasonal variations, or the like, or a combination thereof. Additionally or alternatively, the recommendation algorithm may be trained to focus on weather conditions and user preferences but also balance one or more other factors including, e.g., new content availability, cultural trends, or special events, to provide a well-rounded content recommendation. For example, the recommendation algorithm may be trained to evaluate various factors, assigning distinct weights to each, thereby tailoring the importance of these factors in the decision-making process.

Process 300 may include generating a content recommendation that is specific to digital media. For example, process 300 may include collecting one or more content schedules of content from various broadcasters or streaming services from various content providers and/or platforms. The content schedule(s) may include show times, program types, genres, and/or other relevant metadata of content available at a designated market area (DMA) where the geographical location of the user belongs. Available content may include live broadcasts, streaming content, and any other form of linear or on-demand content. One or more of the content schedules may be updated (regularly or not) to reflect the latest offerings. Process 30 may further include identifying, based on the content schedule(s), content available at the geographical location of the user, and generating the content recommendation by evaluating the identified linear or on-demand content against the user's viewership history and real-time weather information using the recommendation algorithm. The evaluation based on the recommendation algorithm may uncover correlations between the content available based on the content schedule(s), the user's viewing history, and the real-time weather information. Merely by way of example, the evaluation may identify that the user prefers watching comedies on rainy evenings and/or tends to choose documentaries on sunny afternoons. Process 300 may include generating the content recommendation by filtering and/or prioritizing content from the content schedule that aligns closely with the user's historical preferences (as reflected by the user's viewership history) and is suitable for the weather condition. The generated content recommendation may include linear or on-demand content to watch in real-time or within a time window identified based on the evaluation. Process 300 may include notifying the user of an upcoming linear content that aligns with the user's viewership history and the weather information.

In some embodiments, process 300 may include identifying weather-themed content that is themed around the weather condition; and including the weather-themed content in the content recommendation.

In some embodiments, process 300 may include generating a weather-related alert to the user based on the real-time weather information. For example, the weather-related alert may include a notification about at least one of a severe weather condition, a weather forecast change, or a safety warning. In some embodiments, process 300 may include integrating the real-time weather information into the content recommendation. In some embodiments, process 300 may include providing an educational content or advice related to weather preparedness based on the real-time weather information, the user's viewership history, and/or the user's geographical location.

In some embodiments, process 300 may include recommending a set of weather-appropriate activities to the user based on the real-time weather information, the user's viewership history, and/or the user's geographical location. Process 300 may include incorporating the activity recommendation into the content recommendation for presentation to the user.

In some embodiments, process 300 may include monitoring the real-time weather information with respect to a change in the weather condition; and adjusting the content recommendation based on a change in the weather condition that is detected during the monitoring. Accordingly, process 300 may adapt its recommendations not only based on static preference (e.g., user viewership history) but also according to dynamic factors, such as one or more changes in the weather condition, a content schedule, the user's viewership information, or the like, or a combination thereof. For example, process 300 may suggest indoor activities or content during bad weather and outdoor-themed content during good weather. As another example, process 300 may provide an update with respect to an activity suggestion, a content recommendation, an alert, etc., in response to one or more detected changes individually or concurrently (e.g., a change in the weather condition, a change in a content schedule, a change in the user's viewership information, or the like, or a combination thereof). As a further example, process 300 may consider forecasted weather condition provide a proactive content recommendation that aligns with the forecast.

In some embodiments, process 300 may include providing a real-time alert to the user regarding a weather change relevant to a planned activity; and generating a suggestion including alternative activities or content based on these weather changes.

Additionally or alternatively, process 300 may receive (e.g., via data retrieval module 215) user feedback to a content recommendation and updating the content recommendation based on the user feedback. The user may provide user feedback via a user interface. User feedback may be explicit, such as ratings or reviews, or implicit, like watching a recommended show to completion or skipping it. Process 300 may analyze the user feedback to determine user preferences and satisfaction levels with the recommended content. In some embodiments, process 300 may analyze the user feedback by feeding it to the recommendation algorithm. The feedback loop may allow/facilitate the recommendation algorithm to remain relevant and accurate over time. For example, a learning loop may be implemented where user feedback and weather data are fed back into the recommendation algorithm, allowing the algorithm to evolve and adapt over time, thereby ensuring that the recommendations remain relevant and personalized not just to the user's static preferences but also to factors including, e.g., the user's changing mood, interests, and/or needs as influenced by, e.g., the weather.

In some embodiments, process 300 may generate a content recommendation including multiple content items. Process 300 may further include ranking these content items and include the ranking information in the content recommendation to facilitate the user's decision making. The ranking may be performed following the same criterion used for identifying the content items for recommendation, or it may follow a different criterion. For example, process 300 may include ranking the content items based on the same similarity metric used to identify the content items for inclusion in the recommendation. This means the content items are scored and ranked based on how closely they align with the user's modified preference, which combines the user's viewership history and real-time weather data. As another example, the content items in the recommendation are identified based on the user's modified preference but ranked solely based on the user's preference (e.g., as reflected by the user's viewership history), without considering the real-time weather data.

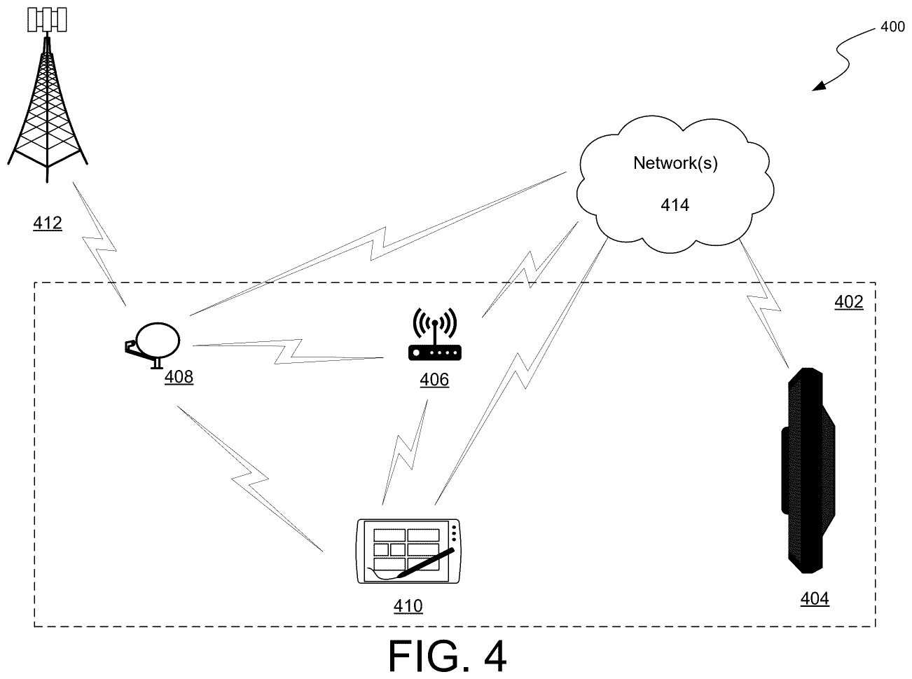

FIG. 4 illustrates an example environment 400 of operation of the disclosed technology. In the example environment illustrated in FIG. 4, area 402 may represent a house, a commercial building, an apartment, a condo, or any other type of suitable dwelling. Inside area 402 is at least one television 404, an over-the-air (OTA) box 406 (e.g., router or broadcast module box), an OTA antenna 408, and a mobile device 410. Each of these devices may be configured to communicate with network(s) 414. OTA box 406 may be configured as a central gateway communicable with various multimedia content providers, networks, devices, and user storage sources, among other servers and databases housing content available for retrieval and display on user devices. Network(s) 414 may be a WiFi network and/or a cellular network. The OTA antenna 408 may also be configured to receive local broadcast signals from local broadcast tower 412 or satellite broadcast tower.

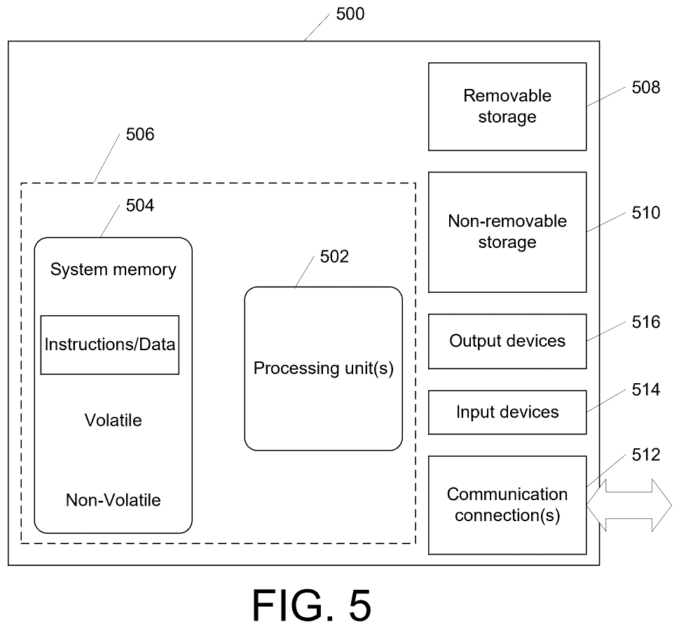

FIG. 5 illustrates one example of a suitable operating environment in which one or more of the present embodiments may be implemented. For example, process 300 may be implemented in the operating environment 500. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network personal computers (PCs), minicomputers, mainframe computers, distributed computing environments that include any of the above systems or devices, and the like.

In an exemplary basic configuration, operating environment 500 typically includes at least one processing unit 502 and memory 504. Depending on the exact configuration and type of computing device, memory 504 (storing, among other things, information related to detected devices, compression artifacts, association information, personal gateway settings, and instruction to perform the methods disclosed herein) may be volatile (such as RAM), non-volatile (such as ROM, flash memory, etc.), or some combination of the two. This most basic configuration is illustrated in FIG. 5 by dashed line 506. Further, environment 500 may also include storage devices (removable 508 and/or non-removable 510) including, but not limited to, magnetic or optical disks or tape. Similarly, environment 500 may also have input device(s) 514 such as keyboard, mouse, pen, voice input, etc., and/or output device(s) 516 such as a display, speakers, printer, etc. Also included in the environment may be one or more communication connections, 512, such as Bluetooth, WiFi, WiMax, LAN, WAN, point to point, etc.

Operating environment 500 typically includes at least some form of computer readable media. Computer readable media can be any available media that can be accessed by processing unit 502 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM EEPROM, flash memory or other memory technology, CD-ROM, digital versatile disks (DVD) or other optical storage, magnetic cassettes, magnetic tape, magnetic disk storage, or other magnetic storage devices, or any other tangible medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulate data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The operating environment 500 may be a single computer (e.g., mobile computer) operating in a networked environment using logical connections to one or more remote computers. The remote computer may be a personal computer, a server, a router, a network PC, a peer device, an OTA antenna, a set-top box, or other common network node, and typically includes many or all of the elements described above as well as others not so mentioned. The logical connections may include any method supported by available communications media. Such networking environments are commonplace in offices, enterprise-wide computer networks, intranets, and the Internet.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of the claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and the alternate aspects falling within the spirit of the broader aspects of the general inventive concept embodied in this application that do not depart from the broader scope of the claimed disclosure.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed is:

1. A computer-implemented method for dynamic content recommendation, comprising:
accessing a user's viewership history stored in non-transitory memory;
obtaining real-time weather information relevant to a weather condition at a geographical location of the user; and
dynamically generating, for presentation, a content recommendation using a recommendation algorithm and based on the viewership history and the real-time weather information, wherein the recommendation algorithm includes a neural network based collaborative filtering algorithm that is trained to adapt recommendations based on patterns identified in viewership information and corresponding weather information.

2. The method of claim 1, wherein the real-time weather information is obtained via an automated data retrieval system interfacing with external weather data sources.

3. The method of claim 1, further comprising:
receiving user feedback through a user interface; and
updating the content recommendation based on the user feedback.

4. The method of claim 1, wherein the content recommendation is specific to digital media.

5. The method of claim 1, further comprising:
identifying content available at the geographical location; and
evaluating the identified content against the user's viewership history and real-time weather information, wherein the generated content recommendation comprises content to watch in real-time or within a time window based on the evaluation.

6. The method of claim 5, further comprising notifying the user of an upcoming content that aligns with the user's viewership history and the weather information.

7. The method of claim 1, wherein the generated content recommendation comprises a plurality of content items, the method further comprising ranking the plurality of content items based on at least one of their respective relevance to the weather information or the user's viewership history.

8. The method of claim 1, further comprising:
identifying weather-themed content that is themed around the weather condition; and
including the weather-themed content in the content recommendation.

9. The method of claim 1, further comprising: generating a weather-related alert to the user based on the real-time weather information, wherein the weather-related alert comprises a notification about at least one of a severe weather condition, a weather forecast change, or a safety warning.

10. The method of claim 1, further comprising: integrating the real-time weather information into the content recommendation.

11. The method of claim 1, wherein the content recommendation includes at least one content item of linear content, on-demand content, or streaming content.

12. The method of claim 1, further comprising:
recommending a set of weather-appropriate activities to the user based on the real-time weather information, the user's viewership history, and/or the user's geographical location.

13. The method of claim 1, further including:
providing an educational content or advice related to weather preparedness based on the real-time weather information, the user's viewership history, and/or the user's geographical location.

14. The method of claim 1, further comprising:
retrieving the geographical location of the user based on a location of a receiving device through which the generated content recommendation is received for presentation to the user.

15. The method of claim 14, further comprising:
providing a real-time alert to the user regarding a weather change relevant to a planned activity; and
generating a suggestion including alternative activities or content based on these weather changes.

16. The method of claim 1, further comprising:
monitoring the real-time weather information with respect to a change in the weather condition; and
adjusting the content recommendation based on a change in the weather condition that is detected during the monitoring.

17. The method of claim 1, further comprising:
receiving authentication information from the user; and
retrieving the user viewership history based on the authentication information.

18. A system comprising:
one or more processors; and
one or more memories storing instructions that, when executed by the one or more processors, cause the system to perform operations comprising:
accessing a user's viewership history stored in a non-transitory memory;
obtaining real-time weather information relevant to a weather condition at a geographical location of the user; and
dynamically generating, for presentation, a content recommendation using a recommendation algorithm and based on the viewership history and the real-time weather information, wherein the recommendation algorithm includes a machine learning model that is trained to adapt recommendations based on patterns identified in viewership information and weather information.

19. A system, comprising:
a data storage device for storing users' viewership histories;
one or more processors equipped with a machine learning algorithm, wherein the one or more processors are configured to perform operations including:
(1) fetching weather information in real-time, and
(2) dynamically generating a content recommendation using the machine learning algorithm and based on viewership histories and the weather information; and
a transmission device configured to transmit the generated content recommendation to a user terminal device.

20. The system of claim 19, wherein:
the transmission device is configured to communicate, via a receiving device, with the user terminal device, and
the operations further include:
determining a geographical location of a user based on information of the receiving device; and
fetching, based on the geographical location of the user, the weather information in real-time for dynamically generating the content recommendation for the user.
